(19) United States
(12) Patent Application Publication
(10) Pub. No.: US 2006/0097776 A1
(43) Pub. Date: May 11, 2006

(54) Voltage applying circuit

(76) Inventor: Masaharu Wada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/066,256

(22) Filed: Feb. 28, 2005

(30) Foreign Application Priority Data
Nov. 8, 2004 (JP) 2004-324393

(51) Int. Cl. G05F 1/10

(52) U.S. Cl. 327/544

(57) ABSTRACT

A voltage applying circuit is provided between a DC/DC converter which lowers a first voltage to generate a second voltage and a load circuit to which the second voltage is to be applied. The voltage applying circuit includes a first terminal to which the first voltage is to be applied, a second terminal connected to the load circuit, a plurality of capacitors, and a switch circuit. The switch circuit connects the capacitors in series between the first terminal and a point of a ground voltage, when the load circuit is in a standby state, and connects the capacitors in parallel between the second terminal and the point of the ground voltage, when the load circuit is in an active state.

### CROSS-REFERENCE TO RELATED APPLICATIONS

This application is based upon and claims the benefit of priority from prior Japanese Patent Application No. 2004-324393, filed Nov. 8, 2004, the entire contents of which are incorporated herein by reference.

### BACKGROUND OF THE INVENTION

1. Field of the Invention

The present invention relates to a voltage applying circuit, and in particular a voltage applying circuit provided with switched capacitors.

2. Description of the Related Art

In recent years, the operating voltages of semiconductor memory devices and electronic equipment such as portable telephones have been reduced to minimize their power consumption. In these devices, for example, a regulator circuit is used in order to lower an external voltage applied from a battery or an external device, thereby obtaining an output voltage.

Furthermore, a decoupling capacitor for smoothing the output voltage of the regulator circuit is connected to an outputting section thereof. In general, the decoupling capacitor has a large capacitance to stabilize the operation of a load circuit to which the output voltage of the regulator circuit is applied.

To bear the decoupling capacitor charged, and maintain the voltage level of the regulator circuit, the regulator circuit must continue to supply a bias current to the decoupling capacitor even when the load circuit is in a standby state. Consequently, the current consumption of the regulator circuit and a semiconductor device provided with the regulator circuit is large. To reduce the current consumption, one possibility is to stop the application of the output voltage of the regulator circuit when the load circuit is in the standby state. However, in this case, the charge in the decoupling capacitor leaks over time, thus lowering the potential of the decoupling capacitor.

Therefore, such a circuit system needs to recharge the decoupling capacitor, when the load circuit is changed from the standby state to the active state. However, this takes a long time, as stated above, since the capacitance of the decoupling capacitor is large.

To be more specific, when a decoupling capacitor having a capacitance of several nanofarads (nF) is charged with current of the order of milliamperes (mA), it takes time of the order of microseconds. In this case, a load circuit having a high operating speed cannot carry out a desired operation.

As this kind of relevant technique, the technique of a voltage-lowering DC/DC converter having high efficiency is disclosed (in Jpn. Pat. Appln. KOKAI Publication No. 2002-204567).

### BRIEF SUMMARY OF THE INVENTION

A voltage applying circuit according to the first aspect of the present invention is provided between a DC/DC converter which lowers a first voltage to generate a second voltage and a load circuit to which the second voltage is to be applied, and comprises:

a first terminal to which the first voltage is to be applied;

a second terminal connected to the load circuit;

a plurality of capacitors; and

a switch circuit which connects the plurality of capacitors in series between the first terminal and a ground voltage, when the load circuit is in a standby state, and which connects the plurality of capacitors in parallel between the second terminal and the ground voltage, when the load circuit is in an active state.

A voltage applying circuit according to the second aspect of the present invention is provided between a DC/DC converter which lowers a first voltage to generate a second voltage and a load circuit to which the second voltage is to be applied, and comprises:

a first terminal to which the first voltage is to be applied;

a second terminal connected to the load circuit;

a first group of capacitors;

a first switch circuit which connects the first group of capacitors in series between the first terminal and a ground voltage, when the load circuit is in a standby state, and which connects the first group of capacitors in parallel between the second terminal and the ground voltage, when the load circuit is in an active state;

a second group of capacitors; and

a second switch circuit which connects the second group of capacitors in series between the first terminal and the ground voltage, when the load circuit is in the standby state, and which connects the second group of capacitors in parallel between the second terminal and the ground voltage, when the load circuit is in the active state.

### BRIEF DESCRIPTION OF THE SEVERAL VIEWS OF THE DRAWING

FIG. 1 is a circuit diagram of the structure of a semiconductor device 1 according to the first embodiment of the present invention.

FIG. 2 is a circuit diagram of a DC/DC converter shown in FIG. 1.

FIG. 3 is a circuit block diagram showing current paths in the semiconductor device 1, which are provided when a load circuit 3 is in a standby state.

FIG. 4 is a circuit block diagram showing current paths in the semiconductor device 1, which are provided when the load circuit 3 is in an active state.

FIG. 5 is a circuit block diagram of the structure of a semiconductor device 10 according to the second embodiment of the present invention.

FIG. 6 is a circuit block diagram showing current paths in the semiconductor device 10, which are provided when the load circuit 3 is in the standby state.

FIG. 7 is a circuit block diagram showing current paths in the semiconductor device 10, which are provided when the load circuit 3 is in the active state.

FIG. 8 is a view showing the result of a simulation with respect to an output voltage Vout.

FIG. 9 is a circuit block diagram of the structure of a semiconductor device 20 according to the third embodiment of the present invention.

FIG. 10 is a circuit block diagram showing current paths in the semiconductor device 20, which are provided when the load circuit 3 is in the standby state.

FIG. 11 is a circuit block diagram showing current paths in the semiconductor device 20, which are provided when the load circuit 3 is in the active state.

### DETAILED DESCRIPTION OF THE INVENTION

Embodiments of the present invention will be explained with reference to the accompanying drawings. In the following description, structural elements having the same functions and same structures will be denoted by the same reference numerals, respectively. After they are each explained one time, their explanations will not be repeated, except as need arises.

### First Embodiment

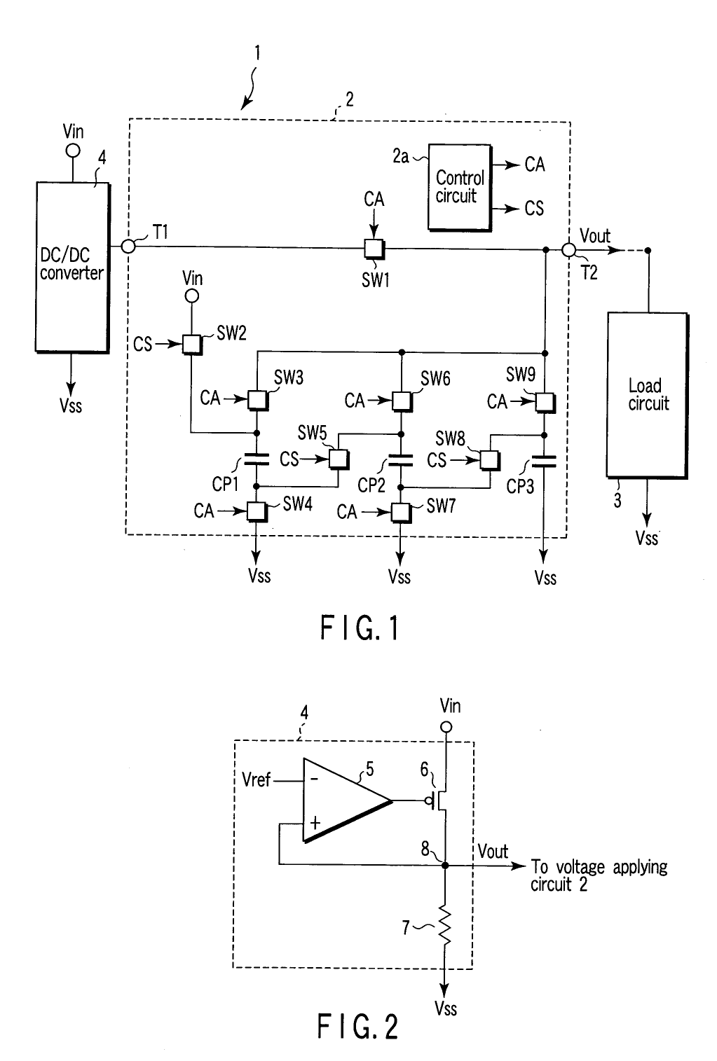

FIG. 1 is a block diagram of the structure of a semiconductor device 1 according to the first embodiment of the present invention. As shown in FIG. 1, the semiconductor device 1 comprises a voltage applying circuit 2, a load circuit 3 and a DC/DC converter 4. The DC/DC converter 4 lowers an input voltage Vin applied from, e.g., an external device, thereby generating an output voltage Vout. The output voltage Vout is applied to the load circuit 3 through a voltage applying circuit 2.

The load circuit 3 is a circuit which comprises a memory and an electronic equipment or a portable telephone, etc., and which receives and uses the output voltage Vout. That is, the DC/DC converter 4 generates a voltage necessary for the load circuit 3. In the first embodiment, the DC/DC converter 4 generates, e.g., a voltage “Vin/3” as the output voltage Vout.

In the first embodiment, the DC/DC converter 4 comprises a voltage-lowering circuit for lowering the input voltage Vin. FIG. 2 is a circuit diagram of the structure of the DC/DC converter 4 comprising the voltage-lowering circuit.

The DC/DC converter 4 comprises a differential amplifier circuit 5, a p-type MOS (Metal Oxide Semiconductor) transistor 6 and a resistor circuit 7. To a negative input terminal (−) of the differential amplifier circuit 5, a reference voltage Vref is applied. The reference voltage Vref may be generated by the DC/DC converter 4 or may be applied form the outside of the semiconductor device 1.

An output terminal of the differential amplifier circuit 5 is connected to the gate of the transistor 6. To the source of the transistor 6, the input voltage Vin is applied. The drain of the transistor 6 is connected to one of the terminals of the resistor circuit 7, with a node 8 interposed therebetween. The other terminal of the resistor circuit 7 is connected to a point of a ground voltage Vss. The node 8 is connected to a positive input terminal (+) of the differential amplifier circuit 5.

The differential amplifier circuit 5 compares a feedback voltage applied to the positive input terminal with the reference voltage Vref. Based on the result of this comparison, the differential amplifier circuit 5 turns on/off the transistor 6, to thereby generate a desired output voltage Vout.

The voltage applying circuit 2 is provided between the load circuit 3 and the DC/DC converter 4. The voltage applying circuit 2 includes an input terminal T1 and an output terminal T2. The input terminal T1 is connected to an output terminal of the DC/DC converter. The output terminal T2 is connected to an input terminal of the load circuit 3.

Furthermore, the voltage applying circuit 2 comprises a control circuit 2a, switches SW1 to SW9, and capacitors CP1 to CP3 having substantially the same capacitance value C.

The switches SW1 to SW9 are formed of n-type MOS transistors. However, they may be formed of p-type MOS transistors or may be formed as analog switches in which n-type MOS transistor and p-type MOS transistor are connected in parallel. If the switches SW1 to SW9 are formed of p-type MOS transistors, the levels of control signals CA and CS for controlling the switches SW1 to SW9, which will be described later, are the inverse of those when the switches SW1 to SW9 are formed of n-type MOS transistors.

To the voltage applying circuit 2, the input voltage Vin is applied through a terminal. The voltage applying circuit 2 comprises a ground terminal (not shown). To the voltage applying circuit 2, the ground voltage Vss is applied through the ground terminal.

One of the terminals of the switch SW1 is connected to the DC/DC converter 4 through the input terminal T1, and the other terminal of the switch SW1 is connected to the load circuit 3 through the output terminal T2.

To one of the terminals of the switch SW2, the input voltage Vin is applied. The other terminal of the switch SW2 is connected to one of the electrodes of a capacitor CP1. One of the terminals of each of the switches SW3, SW6 and SW9 is connected to the output terminal T2.

The other terminal of the switch SW3 is connected to the above-mentioned one of the electrodes of the capacitor CP1, and one of the terminals of each of the switches SW4 and SW5 is connected to the other electrode of the capacitor CP1, and the other terminal of the switch SW4 is connected to the point of the ground voltage Vss.

The other terminal of each of the switches SW5 and SW6 is connected to one of the electrodes of a capacitor CP2, and one of the terminals of each of the switches SW7 and SW8 is connected to the other electrode of the capacitor CP2. The other terminal of the switch SW7 is connected to the point of the ground voltage Vss.

The other electrode of each of the switches SW8 and SW9 is connected to one of the electrodes of a capacitor CP3. The other electrode of the capacitor CP3 is connected to the point of the ground voltage VSS.

The control circuit 2a controls the operation (turning on and off) of each of the switches SW1 to SW9. When the load circuit 3 is in a standby state, the control circuit 2a connects the capacitors CP1 to CP3 in series between a point (terminal) of the input voltage Vin and that of the ground voltage Vss. Also, when the load circuit 3 is in the standby state, the control circuit 2a makes a current path between the DC/DC converter 4 and the load circuit 3 cut off by means of the switch SW1.

On the other hand, when the load circuit 3 is in an active state, the control circuit 2a connects the capacitors CP1 to CP3 in parallel between the output terminal T2 and the point of the ground voltage Vss. Also, when the load circuit 3a is in the active state, the control circuit 2a makes a current path between the DC/DC converter 4 and the load circuit 3 conductive by means of the switch SW1.

Specifically, the control circuit 2a generates the control signals CA and CS, and uses them to perform the above control. The control signal CA is supplied to the switches SW1, SW3, SW4, SW6, SW7 and SW9, and the control signal CS is supplied to the switches SW2, SW5 and SW8. In the first embodiment, the control signals CA and CS are supplied to the gate electrode of the n-type MOS transistors of which the switches SW1 to SW9 are formed.

In the case where a signal for effecting switching between the active and standby states of the load circuit 3 is supplied from the outside of the semiconductor device 1, it can be directly supplied to each of the switches SW1 to SW9. In this case, the voltage applying circuit 2 does not need to have the control circuit 2a. Alternatively, the voltage applying circuit 2 may be formed to generate the control signals CA and CS on the basis of a signal indicating the active and standby states.

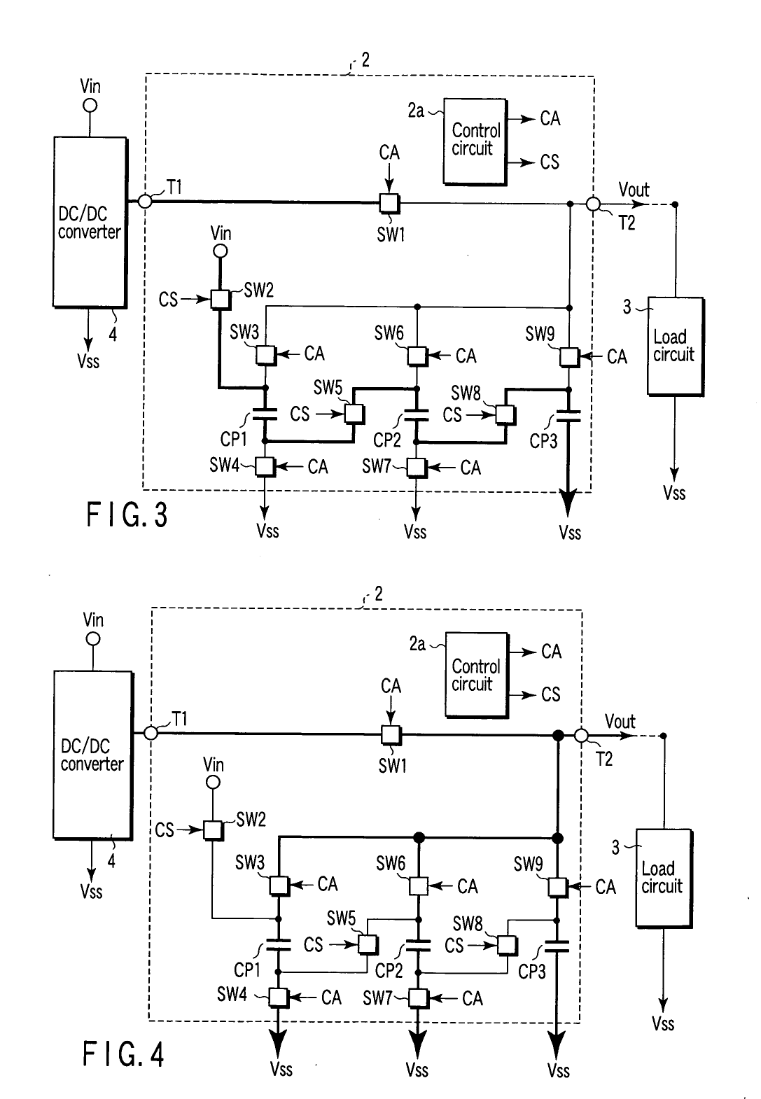

The operation of the semiconductor device 1 having the above structure will be explained. First, how the semiconductor device 1 operates in the case the load circuit 3 is in the standby state will be explained. FIG. 3 is a circuit diagram showing current paths in the semiconductor device 1, which are provided in the case where the load 3 is in the standby state. The current paths are indicated by bold line.

When the load circuit 3 is in the standby state, the control circuit 2a outputs a control signal CA having a low level and a control signal CS having a high level. Thereby, the switches SW1, SW3, SW4, SW6, SW7 and SW9 are turned off, and the switches SW2, SW5 and SW8 are turned on.

The switch SW1 reduces a leak current from the DC/DC converter 4, because the switch SW1 is turned off it in the standby state. Accordingly, the current consumption of the DC/DC converter 4 can be reduced.

Moreover, when the load circuit 3 is in the standby state, the input voltage Vin is applied to the capacitor CP1. Furthermore, the capacitors CP1 to CP3 are connected in series, whereby each of them is charged at a voltage “Vin/3”.

It should be noted that an electric charge in each of the above capacitors, which is denoted by “q”, is expressed by the following equation:
q=C×(Vin/3)

Therefore, an electric charge in the voltage applying circuit 2, which is denoted by “Q”, is expressed by the following equation:
Q=3q

Next, it will be explained how the semiconductor device 1 operates when the load circuit 3 is in the active state. FIG. 4 is a circuit diagram showing current paths in the semiconductor device 1, which are provided when the load circuit 3 is in the active state. The current paths are indicated by bold line in FIG. 4.

When the load circuit 3 is in the active state, the control circuit 2a outputs a control signal CA having a high level and a control signal CS having a low level. Thereby, the switches SW1, SW3, SW4, SW6, SW7 and SW9 are turned on, and the switches SW2, SW5 and SW8 are turned off.

Also, when the load circuit 3 is in the active state, the output voltage Vout of the DC/DC converter 4 is applied to the load circuit 3. Furthermore, when the load circuit 3 is in the active state, and then when the switch SW2 is turned off, applying of the input voltage Vin to the voltage applying circuit 2 is stopped. In addition, the capacitors CP1 to CP3 are connected in parallel. Thereby, each of the capacitors CP1 to CP3 applies the voltage “Vin/3” to the load circuit 3.

In this case, an electric charge which can be supplied by the voltage applying circuit 2 satisfy the equation “Q=3q”. Thus, the electric charge can be set by changing the capacitance value C of each of the capacitors CP1 to CP3.

In such a manner, in the first embodiment, the voltage applying circuit 2 includes three switched capacitors, which are located between the DC/DC converter 4 and the load circuit 3. When the load circuit 3 is in the standby state, the three switched capacitors are connected in series and charged. On the other hand, when the load circuit 3 is in the active state, the three switched capacitors are connected in parallel to apply a voltage to the load circuit 3.

Therefore, according to the first embodiment, the output voltage Vout can be raised at a high speed. Thereby, even when an operating speed of the load circuit 3 is higher, the load circuit 3 can achieve a desired operation.

Moreover, when the load circuit 3 is in the standby state, the DC/DC converter 4 does not need to supply a bias current to a decoupling capacitor. Accordingly, the current consumption of the semiconductor device 1 is reduced.

Furthermore, the voltage applying circuit 2 can generate a voltage obtained by lowering the input voltage Vin. Thereby, the voltage applying circuit 2 can generate a voltage corresponding to the output voltage Vout of the DC/DC converter 4.

In addition, the capacitors CP1 to CP3, which are connected in parallel between the output terminal T2 and the point of the ground voltage Vss when the load circuit 3 is in the active state, also have a function of smoothing the output voltage Vout output from the DC/DC converter 4. That is, the voltage applying circuit 2 doubles as the decoupling capacitor. Thus, the semiconductor device 1 does not need to have a decoupling capacitor, thus restricting an increase in the total circuit area due to the voltage applying circuit 2.

In the first embodiment, a voltage, which is a third the input voltage Vin, is generated. However, an arbitrary voltage can be generated by changing the number of switched capacitors to be provided.

### Second Embodiment

In the second embodiment, two voltage applying circuit each having switched capacitors are provided between the DC/DC converter 4 and the load circuit 3.

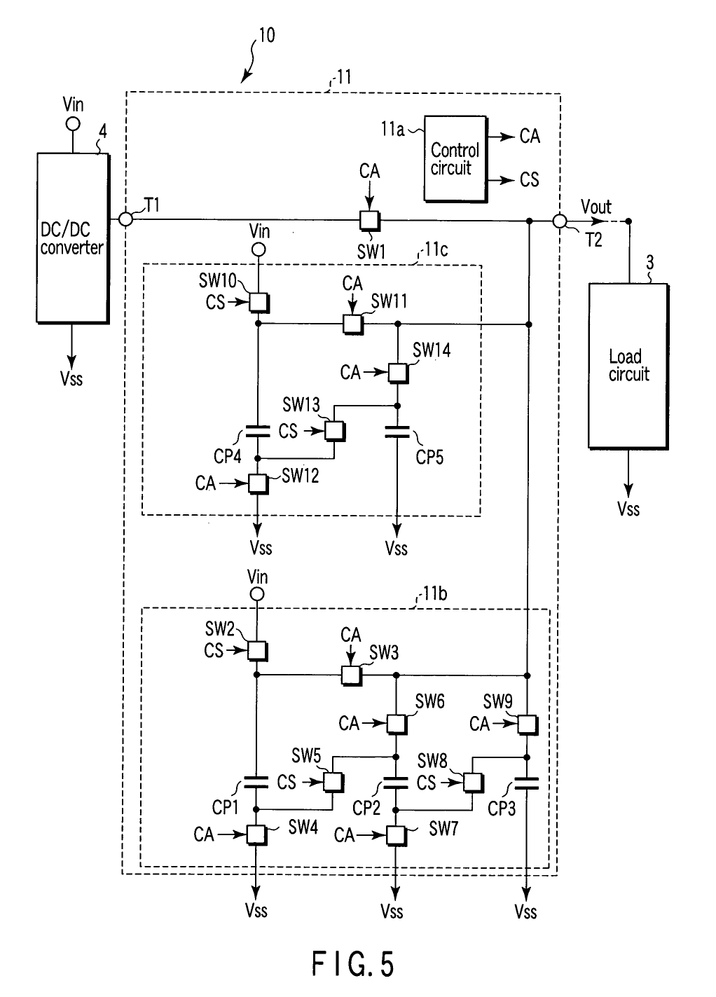

FIG. 5 is a circuit block diagram of the structure of a semiconductor device 10 according to the second embodiment of the present invention. The semiconductor device 10 comprises a voltage applying circuit 11, the load circuit 3 and the DC/DC converter 4.

The voltage applying circuit 11 comprises a control circuit 11a, a first voltage applying section 11b and a second voltage applying section 11c. The first voltage applying section 11b comprises switches SW2 to SW9 and capacitors CP1 to CP3 having substantially the same capacitance value C1.

The second voltage applying section 11c comprises switches SW10 to SW14 and capacitors CP4 and CP5 having substantially the same capacitance value C2. The switches SW10 to SW14 are formed of, e.g., n-type MOS transistors.

To the second voltage applying section 11c, the input voltage Vin is applied. To one of the terminals of the switch SW10, the input voltage Vin is applied. The other terminal of the switch SW10 is connected to one of the electrodes of the capacitor CP4. One of the terminals of each of the switches SW11 and SW14 is connected to the output terminal T2.

The other terminal of the switch SW11 is connected to one of the terminals of the capacitor CP4. One of the terminals of each of the switches SW12 and SW13 is connected to the other terminal of the capacitor CP4. The other terminal of the switch SW12 is connected to the point of the ground voltage Vss.

The other terminal of each of the switches SW13 and 14 is connected to one of the electrodes of the capacitor CP5. The other electrode of the capacitor CP5 is connected to the point of the ground voltage Vss.

The control circuit 11a controls the operation (turning on and off) of each of the switches SW1 to SW14. When the load circuit 3 is in the standby state, the control circuit 11a connects the capacitors CP1 to CP3 in series between the point of the input voltage Vin and that of the ground voltage Vss. Also, when the load circuit 3 is in the standby state, the control circuit 11a connects the capacitors CP4 and CP5 in series between the point of the input voltage Vin and that of the ground voltage Vss. Furthermore, when the load circuit 3 is in the standby state, the control circuit 11a makes a current path between the DC/DC converter 4 and the load circuit 3 cut off inhibits current from flowing through the current path between the DC/DC converter 4 and the load circuit 3.

On the other hand, when the load circuit 3 is in the active state, the control circuit 11a connects the capacitors CP1 to CP3 in parallel between the output terminal T2 and the point of the ground voltage Vss. When the load circuit 3 is in the active state, the control circuit 11a connects the capacitors CP4 and CP5 in parallel between the output terminal T2 and the point of the ground voltage Vss.

To be more specific, the control circuit 11a generates the control signals CA and CS. That is, the control circuit 11a uses the control signals CA and CS to perform the above control. The control signal CA is supplied to the switches SW1, SW3, SW4, SW6, SW7, SW9, SW11, SW12 and SW14. The control signal CS is supplied to the switches SW2, SW5, SW8, SW10 and SW13.

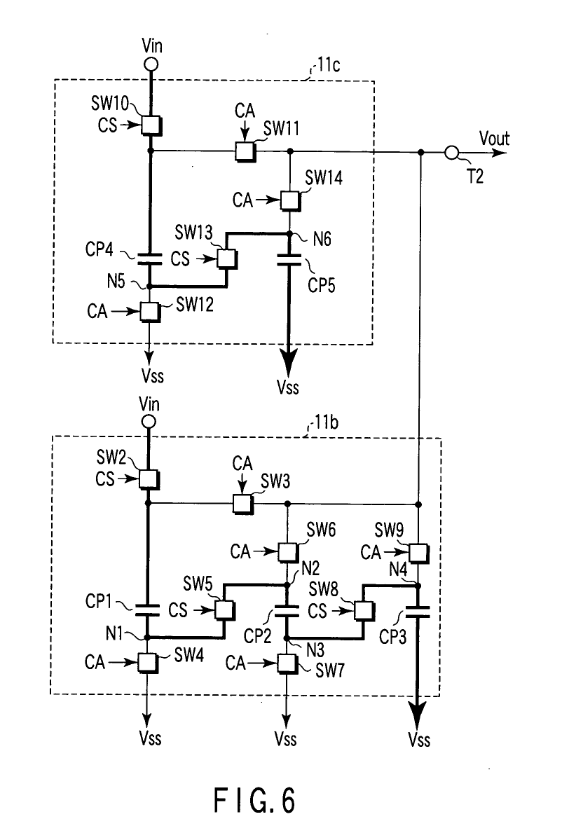

The operation of the semiconductor device 10 having the above structure will be explained. First, it will be explained how the semiconductor device 10 operates when the load circuit 3 is in the standby state. FIG. 6 is a circuit block diagram showing current paths in the semiconductor device 10, when are provided when the load circuit 3 is in the standby state.

When the load circuit 3 is in the standby state, the control circuit 11a outputs a control signal CA having a low level and a control signal CS having a high level. Thereby, the switches SW11, SW12 and SW14 are turned off, and the switches SW10 and SW13 are turned on.

Also, when the load circuit 3 is in the standby state, the input voltage Vin is applied to the capacitor CP4. Further, the capacitors CP4 and CP5 are connected in series. As a result, each of the capacitors CP4 and CP5 is charged at a voltage “Vin/2”.

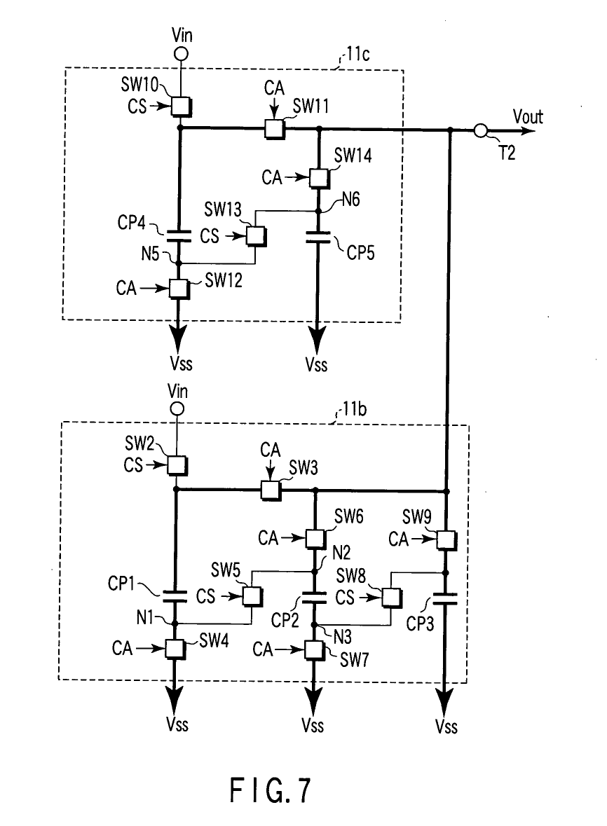

Next, it will be explained how the semiconductor device 10 operates when the load circuit 3 is in the active state. FIG. 7 is a circuit block diagram showing current paths in the semiconductor device 10, which are provided when the load circuit 3 is in the active state. When the load circuit 3 is in the active state, the control circuit 11a outputs a control signal CA having a high level and a control signal CS having a low level. Thereby, the switches SW11, SW12 and SW14 are turned on, and the switches SW10 and SW13 are turned off.

When the load circuit 3 is in the active state, the output voltage Vout of the DC/DC converter 4 is applied to the load circuit 3. Also, when the load circuit 3 is in the active state, the switch SW10 is turned off, thereby stopping applying of the input voltage Vin to the first voltage supplying section 11c. Furthermore, the capacitors CP4 and CP5 are connected in parallel. Thereby, each of the capacitors CP4 and CP5 applies a voltage “Vin/2” to the load circuit 3.

The operations of the first voltage applying section 11b and the switch SW1 are the same as those in the first embodiment. Therefore, an intermediate voltage between the voltages “Vin/2” and “Vin/3” is applied from the output terminal T2 to the load circuit 3.

The following equation (1) is an equation which is satisfied according to the law of conservation of charge, when the input voltage Vin=3.3V, and the output voltage Vout=1.2V.
3−C1×V1+2·C2×V2=(3·C1+2·C2)×Vout (1)

where V1 is the output voltage of the first voltage applying section 11b, and V2 is the output voltage of the second voltage applying section 11c.

The equation (1) is reduced to the following equation (2):
3·V1+2−V2·A=(3+2·A)×Vout (2)

where A is the ratio of the capacitance value C2 to the capacitance value C1 (C2/C1).

The equation (2) is reduced to the following equation (3):
3·V1−3Vout=A(2·Vout−2·V2) (3)

From the equation (3), the above capacitance ratio A is expressed by the following equation:
A=3·(V1−Vout)/(2·(Vout−V2)) (4)

Since V1=Vin/3, and V2=Vin/2, when the input voltage Vin=3.3V, and the output voltage Vout=1.2V, the capacitance ratio A is expressed by the following:
A=1/3 (5)

If C1=900 pF, C2=300 pF.

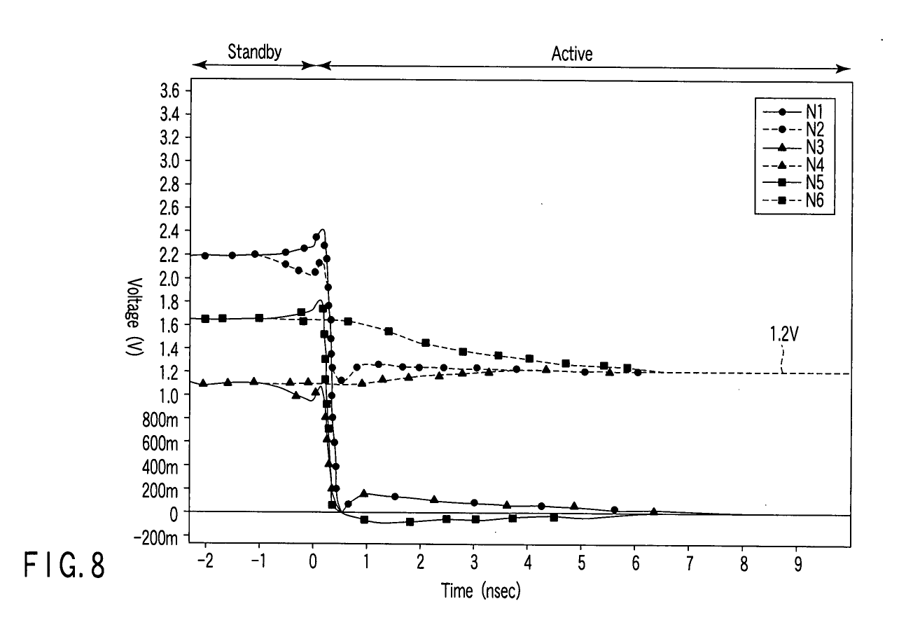

When the output voltage Vout is simulated by using the numerical values in the above case, a result is obtained as shown in FIG. 8. In FIG. 8, voltage values of nodes N1 to N6 in FIGS. 6 and 7 are shown, and the vertical axis and horizontal axis in FIG. 8 indicate the voltage (V) and time (nsec), respectively. Also, the temporal axis indicates time at which the above standby state is changed to the active state, as “0”.

As can be seen from FIG. 8, when approximately 6 nanoseconds lapse after the standbys state is changed to the active state, the output voltage Vout (=1.2V) is stably output.

As explained above in detail, the output voltage Vout can be raised at a high speed. In addition, the other advantages are the same as those in the first embodiment.

Furthermore, the voltage applying circuit has two voltage applying sections which are different from each other in the number of capacitors. Accordingly, the voltage can be more finely set than in the first embodiment.

### Third Embodiment

In the third embodiment, a voltage applying circuit is formed to have two voltage applying sections which are different from those in the second embodiment in the number of capacitors.

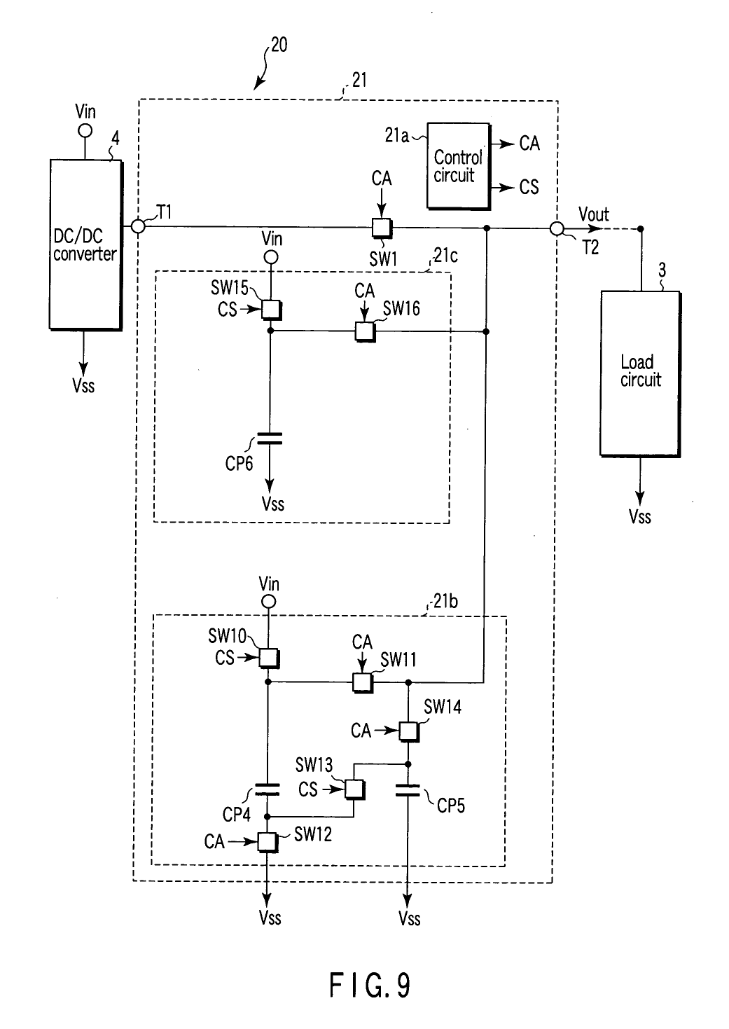

FIG. 9 is a circuit block diagram of the structure of a semiconductor device 20 according to the third embodiment. The semiconductor device 20 comprises a voltage applying circuit 21, the load circuit 3 and the DC/DC converter 4.

The voltage applying circuit 21 comprises a control circuit 21a, a first voltage applying section 21b and a second voltage applying circuit 21c. The first voltage applying section 21b comprises switches SW10 to SW14 and capacitors CP4 and CP5 having substantially the same capacitance value C2.

The second voltage applying section 21c comprises switches SW15 and SW16 and capacitor CP6 having substantially the same capacitance value C3. The switches SW15 and SW16 are formed of, e.g., n-type MOS transistors.

To the second voltage applying section 21c, an input voltage Vin is applied. To one of the terminals of the switch SW15, the input voltage Vin is applied. The other terminal of the switch SW15 is connected to one of the electrodes of the capacitor CP6. One of the terminals of the switch SW16 is connected to the output terminal T2.

The other terminal of the switch SW16 is connected to one of the electrodes of the capacitor CP6. The other electrode of the capacitor CP6 is connected to the point of the ground voltage Vss.

The control circuit 21a controls the operation (turning on and off) of each of the switches SW1 and SW 10 to SW16. When the load circuit 3 is in the standby state, the control circuit 21a connects the capacitor CP6 in series between the point of the input voltage Vin and the point of the ground voltage Vss. Also, when the load circuit 3 is in the standby state, the control circuit 21a connects the capacitors CP4 and CP5 in series between the point of the input voltage Vin and that of the ground voltage Vss. Furthermore, when the load circuit 3 is in the standby state, the control circuit 21a makes the current path between the DC/DC converter 4 and the load circuit 3 cut off.

On the other hand, when the load circuit 3 is in the active state, the control circuit 21a connects the capacitor CP6 in parallel between the output terminal T2 and the point of the ground voltage Vss. Also, when the load circuit 3 is in the active state, the control circuit 21a connects the capacitors CP4 and CP5 in parallel between the output terminal T2 and the point of the ground voltage Vss.

Specifically, the control circuit 21a generates the control signals CA and CS. That is, the control circuit 21a uses the control signals CA and CS to perform the above control. The control signal CA is supplied to the switches SW1, SW11, SW12, SW14 and SW16, and the control signal CS is supplied to the switches SW10, SW13 and SW15.

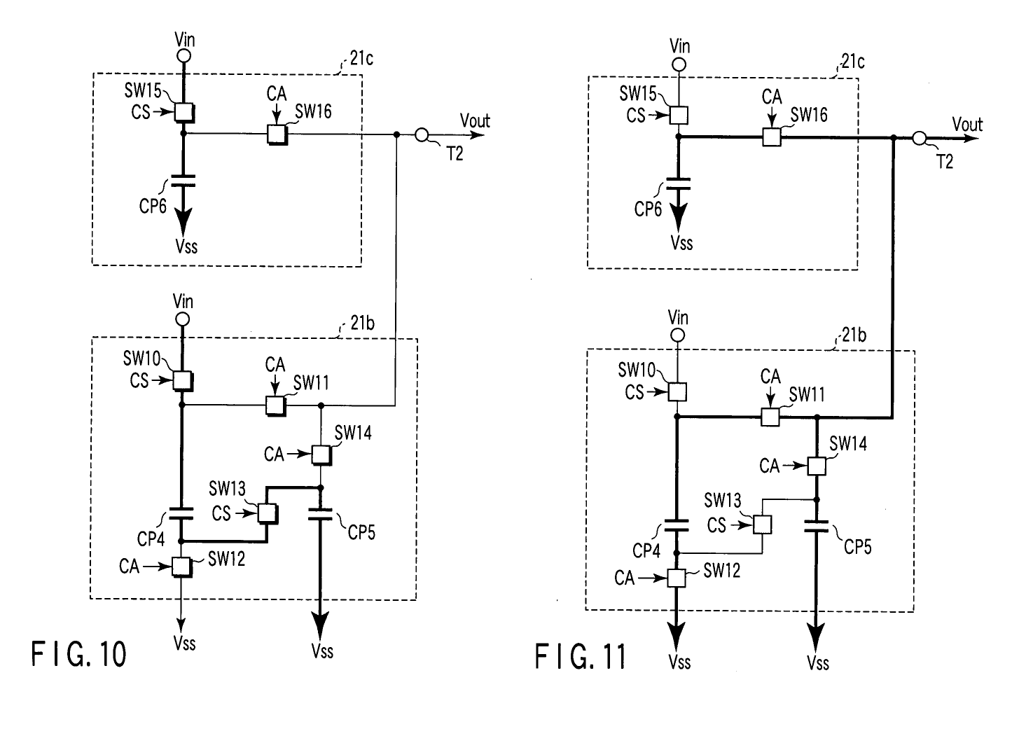

The operation of the semiconductor device 20 having the above structure will be explained. First, it will be explained how the semiconductor device 20 operates when the load circuit 3 is in the standby state. FIG. 10 is a circuit block diagram showing current paths in the semiconductor device 20, which are provided when the load circuit 3 is in the standby state.

When the load circuit 3 is in the standby state, the control circuit 21a outputs a control signal CA having a low level and a control signal CS having a high level. Thereby, the switch SW16 is turned off, and the switch SW15 is turned on.

Also, when the load circuit 3 is in the standby state, the input voltage Vin is applied to the capacitor CP6. As a result, the capacitor CP6 is charged at the voltage “Vin”.

Next, it will be explained how the semiconductor device 10 operates when the load circuit 3 is in the active state. FIG. 11 is a block diagram showing current paths in the semiconductor device, which are provided when the load circuit 3 is in the active state. When the load circuit 3 is in the active state, the control circuit 21a outputs a control signal CA having a high level and a control signal CS having a low level. Thereby, the switch SW16 is turned on, and the switch SW15 is turned off.

When the load circuit 3 is in the active state, the output voltage Vout of the DC/DC converter 4 is applied to the load circuit 3. Also, when the load circuit 3 is in the active state, the switch SW15 is turned off, thereby stopping applying of the input voltage Vin to the first voltage applying section 21c. Furthermore, the capacitor CP6 is connected in parallel between the output terminal T2 and the point of the ground voltage Vss. Thereby, the capacitor CP6 applies the voltage “Vin” to the load circuit 3.

The operation of the first voltage applying section 21b is the same as the second voltage applying section 11c in the second embodiment. Therefore, an intermediate voltage between the voltages “Vin” and “Vin/2” is applied from the output terminal T2 to the load circuit 3.

By virtue of the above features of the third embodiment, the same advantages can be obtained as in the second embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A voltage applying circuit provided between a DC/DC converter which lowers a first voltage to generate a second voltage and a load circuit to which the second voltage is to be applied, comprising:
a first terminal to which the first voltage is to be applied;
a second terminal connected to the load circuit;
a plurality of capacitors; and
a switch circuit which connects the plurality of capacitors in series between the first terminal and a point of a ground voltage, when the load circuit is in a standby state, and which connects the plurality of capacitors in parallel between the second terminal and the point of the ground voltage, when the load circuit is in an active state.

2. The voltage applying circuit according to claim 1, which further comprises a first switch element which electrically disconnects the DC/DC converter and the load circuit from each other, when the load circuit is in the standby state, and which electrically connects the DC/DC converter and the load circuit to each other, when the load circuit is in the active state.

3. The voltage applying circuit according to claim 2, which further comprises a second switch element which applies the first voltage to the plurality of capacitors when the load circuit is in the standby state, and which stops applying of the first voltage to the plurality of capacitors, when the load circuit is in the active state.

4. The voltage applying circuit according to claim 1, wherein the plurality of capacitors have substantially the same capacitance value.

5. The voltage applying circuit according to claim 4, wherein the number of the plurality of capacitors is set to cause an output voltage from the second terminal to be substantially equal to the second voltage when the plurality of capacitors are connected in parallel between the second terminal and the point of the ground voltage.

6. The voltage applying circuit according to claim 5, wherein the number of the plurality of capacitors is set to cause a voltage of each of the plurality of capacitors to correspond to the second voltage when the plurality of capacitors are connected in series between the first terminal and the point of the ground voltage.

7. The voltage applying circuit according to claim 1, wherein the plurality of capacitors have a function of smoothing the second voltage applied from the DC/DC converter when the load circuit is in the active state.

8. The voltage applying circuit according to claim 3, wherein:
the plurality of capacitors are first to third capacitors;
the switch circuit includes third to ninth switch elements, one of terminals of the third switch element is connected to the second terminal, and the other terminal of the third switch element is connected to one of electrodes of the first capacitor;
one of terminals of the fourth switch element is connected to the other electrode of the first capacitor, and the other terminal of the fourth element is connected to the point of the ground voltage;
one of terminals of the fifth switch element is connected to the other electrode of the first capacitor, and the other terminal of the fifth switch element is connected to one of electrodes of the second capacitor;
one of terminals of the sixth switch element is connected to the second terminal, and the other terminal of the sixth switch element is connected to said one of the terminals of the second capacitor;
one of terminals of the seventh switch element is connected to the other electrode of the second capacitor, and the other terminal of the seventh switch element is connected to the point of the ground voltage;
one of terminals of the eighth switch element is connected to the other electrode of the second capacitor, and the other terminal of the eighth switch element is connected to one of electrodes of the third capacitor; and
one of terminals of the ninth switch element is connected to the second terminal, and the other terminal of the ninth switch element is connected to said one of the electrodes of the third capacitor.

9. The voltage applying circuit according to claim 8, wherein each of the first to ninth switch elements is formed of a MOS (Metal Oxide Semiconductor) transistor.

10. A voltage applying circuit provided between a DC/DC converter which lowers a first voltage to generate a second voltage and a load circuit to which the second voltage is to be applied, comprising:
a first terminal to which the first voltage is to be applied;
a second terminal connected to the load circuit;
a first group of capacitors;
a first switch circuit which connects the first group of capacitors in series between the first terminal and a point of a ground voltage, when the load circuit is in a standby state, and which connects the first group of capacitors in parallel between the second terminal and the point of the ground voltage, when the load circuit is in an active state;
a second group of capacitors; and
a second switch circuit which connects the second group of capacitors in series between the first terminal and the point of the ground voltage, when the load circuit is in the standby state, and which connects the second group of capacitors in parallel between the second terminal and the point of the ground voltage, when the load circuit is in the active state.

11. The voltage applying circuit according to claim 10, which further comprises a first switch element which electrically disconnects the DC/DC converter and the load circuit from each other, when the load circuit is in the standby state, and which electrically connects the DC/DC converter and the load circuit to each other, when the load circuit is in the active state.

12. The voltage applying circuit according to claim 11, which further comprises a second switch element which applies the first voltage to the first and second groups of capacitors, when the load circuit is in the standby state, and which stops applying of the first voltage to the first and second groups of capacitors, when the load circuit is in the active state.

13. The voltage applying circuit according to claim 10, wherein the first group of capacitors have substantially the same first capacitance value, and the second group of capacitors have substantially the same second capacitance value.

14. The voltage applying circuit according to claim 13, wherein the number of the first group of capacitors is different from the number of the second group of capacitors.

15. The voltage applying circuit according to claim 14, the number of the first group of capacitors and the number of the second group of capacitors are set to cause an output voltage from the second terminal to be equal to the second voltage, when the first group of capacitors are connected in parallel between the second terminal and the point of the ground voltage, and the second group of capacitors are connected in parallel between the second terminal and the point of the ground voltage.

16. The voltage applying circuit according to claim 10, wherein the first and second groups of capacitors have a function of smoothing the second voltage applied from the DC/DC converter when the load circuit is in the active state.

17. The voltage applying circuit according to claim 12, wherein:
the first group of capacitors are first to third capacitors;
the second group of capacitors are forth and fifth capacitors;
the first switch circuit includes third to ninth switch elements;
one of terminals of the third switch element is connected to the second terminal, and the other terminal of the third switch element is connected to one of electrodes of the first capacitor;
one of terminals of the fourth switch element is connected to the other electrode of the first capacitor, and the other terminal of the fourth switch element is connected to the point of the ground voltage;
one of terminals of the fifth switch element is connected to the other electrode of the first capacitor, and the other terminal of the fifth switch element is connected to one of electrodes of the second capacitor;
one of terminals of the sixth switch element is connected to the second terminal, and the other terminal of the sixth switch element is connected to said one of the electrodes of the second capacitor;
one of terminals of the seventh switch element is connected to the other electrode of the second capacitor, and the other terminal of the seventh switch element is connected to the point of the ground voltage;
one of terminals of the eighth switch element is connected to the other electrode of the second capacitor, and the other terminal of the eighth switch element is connected to one of electrodes of the third capacitor;
one of terminals of the ninth switch element is connected to the second terminal, and the other terminal of the ninth switch element is connected to said one of the electrodes of the third capacitor;
the second switch circuit includes tenth to thirteenth switch elements;
one of terminals of the tenth switch element is connected to the second terminal, and the other terminal of the tenth switch element is connected to one of electrodes of the fourth capacitor;
one of terminals of the eleventh switch element is connected to the other electrode of the fourth capacitor, and the other terminal of the eleventh switch element is connected to the point of the ground voltage;
one of terminals of the twelfth switch element is connected to the other electrode of the fourth capacitor, and the other terminal of the twelfth switch element is one of electrodes of the fifth capacitor; and
one of terminals of the thirteenth switch element is connected to the second terminal, and the other terminal of the thirteenth switch element is connected to said one of the electrodes of the fifth capacitor.

18. The voltage applying circuit according to claim 17, wherein each of the first to thirteenth switch elements is formed of a MOS transistor.
